(19) United States
(12) Patent Application Publication
(10) Pub. No.: US 2011/0282784 A1
(43) Pub. Date: Nov. 17, 2011

(54) SYSTEMS AND METHODS FOR REASSIGNMENT OF A VIRTUAL CARD

(75) Inventor: David A. Nelsen, Lake Oswego, OR (US)

(73) Assignee: GIFTANGO CORPORATION, Portland, OR (US)

(21) Appl. No.: 13/107,654

(22) Filed: May 13, 2011

Related U.S. Application Data
(60) Provisional application No. 61/345,037, filed on May 14, 2010.

(51) Int. Cl. G06Q 40/00

(52) U.S. Cl. 705/41

(57) ABSTRACT

A method stored in memory executable by a processor for transferring ownership of a virtual value card in a virtual card management system is provided. The method includes, at a virtual card manager, receiving a request for reassignment of the virtual value card from a source virtual card engine to a target virtual card engine at a virtual card manager. The method further includes, at the virtual card manager, modifying card data in a manager-side associative card profile included in the virtual card manager and requesting modification of card data in a provider-side associative card profile to permit use of the virtual value card by the target virtual card engine and inhibit use of the virtual value card by the source virtual card engine in response to reception of the request for reassignment.

### CROSS-REFERENCE TO RELATED APPLICATIONS

This application claims priority to U.S. Provisional Patent Application No. 61/345,037 filed May 14, 2010 entitled “SYSTEMS AND METHODS FOR REASSIGNMENT OF A VIRTUAL CARD” the entire contents of which are hereby incorporated herein by reference for all purposes.

### FIELD

The present disclosure relates generally to systems and methods to manage and use a virtual card.

### BACKGROUND AND SUMMARY

Plastic gift cards have become a popular form of payment in today's marketplace. In this regard, consumers may purchase a select merchants gift card (such as a plastic gift card) and then present the plastic gift card to a brick and mortar location for redemption. However, there are many difficulties in managing a large number of plastic cards maintained by a consumer. For example, when a consumer manages a number of these cards, a consumer may physically stretch their wallet to carry the large number of cards and it may be difficult to locate a desired plastic card for use due to the number of cards. Due to the large number of plastic cards now offered, a consumer may desire to retain such cards while reducing the number of cards that are carried in the physical wallet or purse. However, when the plastic cards are not carried for use, in some examples, a consumer may lose the plastic gift card or fail to bring the plastic gift card to the brick and mortar store for redemption resulting in frustration with plastic gift cards.

As mentioned above, the issuance of a plastic card increases the potential for loss or misplacement of the card. Furthermore, fraudulent use of cards may occur if the card is lost and then redeemed by a third party. The fraudulent use of the cards may negatively affect the card holder, goods and services system, and/or the card service provider as well as the industry as a whole.

As the inventors herein have recognized the difficulties with the plastic issued cards, alternative methods and systems for electronic cards have been developed. These electronically-issued and managed cards are referred to herein as virtual cards. The virtual cards may include, but are not limited to, one or more of a virtual gift card, a virtual loyalty card, a virtual membership card, and a virtual rewards card.

As described in more detail below, the inventors herein have provided systems and methods for reassigning a virtual value card from a source virtual card engine to a target virtual card engine. As such in one example, a method stored in memory executed by a processor for transferring ownership of a virtual value card in a virtual card management system is provided. The method includes, at a virtual card manager, receiving a request for reassignment of the virtual value card from a source virtual card engine to a target virtual card engine. The method further includes, at the virtual card manager, modifying card data in a manager-side associative card profile included in the virtual card manager and requesting modification of card data in a provider-side associative card profile to permit use of the virtual value card by the target virtual card engine and inhibit use of the virtual value card by the source virtual card engine in response to reception of the request for reassignment. The method may further include, at the virtual card manager, requesting transfer of the virtual value card to the source virtual card engine from the target virtual card engine, subsequent to modifying card data. In this way, a virtual value card can be reassigned, expanding the versatility of the virtual value card.

Further in some examples, modifying card data in a manager-side associative card profile includes authorizing the target virtual card engine for selective enablement of the virtual value card and inhibiting the source virtual card engine from selective enablement of the virtual value card, selective enablement includes setting the virtual value card in an enabled and disabled state. Authorizing the target virtual card engine for selective enablement and inhibiting the source virtual card engine from selective enablement of the virtual value card increases the security of the virtual value card. As a result the likelihood of fraudulent card use by a third party is decreased.

Additional security measures may be employed during reassignment of a virtual value card. For example, the method may further include subsequent to the step of modifying, at the virtual card manager, setting the virtual value card in a disabled state while retaining an active status of the virtual value card. The method may further include at the virtual card manager, subsequent to transferring the virtual value card to the source virtual card engine, receiving a verification of virtual value card reception from the source virtual card engine that the virtual value card has been received, and in response to the reception of the verification setting the virtual value card in an enabled state while retaining the virtual value card in an active status. In this way, use of the virtual value card during reassignment is inhibited, increasing the security of the virtual value card during reassignment.

### BRIEF DESCRIPTION OF THE FIGURES

The disclosure is illustrated by way of example and not by way of limitation in the figures of the accompanying drawings, in which the like references indicate similar elements and in which:

FIG. 1 shows an exemplary schematic illustration of a virtual card management system according to an embodiment of the present disclosure.

FIG. 2A shows an example virtual card engine that may be included in the virtual card management system shown in FIG. 1, according to an embodiment of the present disclosure.

FIG. 2B shows an example enablement module that may be included in the virtual card management system shown in FIG. 1, according to an embodiment of the present disclosure.

FIG. 2C shows an example integration connection engine that may be included in the virtual card management system shown in FIG. 1, according to an embodiment of the present disclosure.

FIGS. 3A and 3B show a method for managing a virtual card according to an embodiment of the present disclosure.

FIGS. 4-9 show examples of a computing device which may present various content windows to enable the functionality of the virtual card engine shown in FIG. 2, according to several embodiments of the present disclosure.

FIG. 10 shows a content window that may be used by the goods and services system, shown in FIG. 1, to access the reporting module, shown in FIG. 2, according to an embodiment of the present disclosure.

### DETAILED DESCRIPTION

A method for reassignment of a virtual value card from a source virtual card engine to a target virtual card engine is described herein. Reassignment of the virtual value card enables ownership of the virtual card to be transferred from one person to another electronically. Additionally, systems and methods have been developed to increase the security of a virtual card during reassignment of a virtual card to reduce the likelihood of fraudulent use of the virtual card. For example, the virtual value card may be selectively enabled during various steps in the reassignment process to increase security. Still further, systems and methods have been developed to alter various aspects of the virtual card, such as the virtual card's value and appearance, to enable customization of the virtual card during reassignment. In this way, a person may tailor the reassignment process according to their predilection.

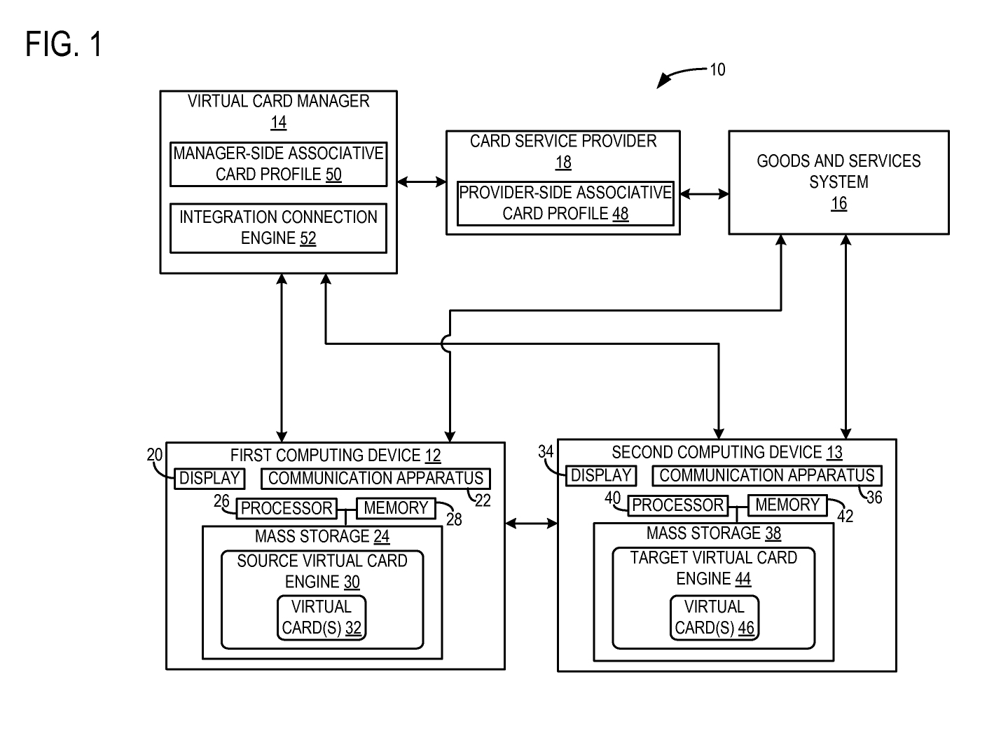

FIG. 1 shows an exemplary schematic illustration of a virtual card management system 10 according to an embodiment of the present disclosure. As described below, the system enables a user of a source virtual card engine to manage and use one or more virtual cards as well as reassign a virtual card to a target virtual card engine from a source virtual card engine.

Virtual card as used herein may be an electronically-issued and/or electronically maintained virtual value card. A virtual value may be any type of privilege, monetary or non-monetary. For example, a virtual value card may be a stored value card which may include, but is not limited to, a virtual gift card, a virtual loyalty card, a virtual rewards card, a prepaid card, or another suitable virtual card that holds prepaid value. Thus, the virtual value card may retain stored value. The stored value card may have monetary or other forms of value stored on the virtual card. In another example, a virtual value card may be a virtual membership card where such stored value includes membership privileges or identification-related privileges. An example of virtual membership cards may include, but are not limited to, virtual identification cards, club cards, promotional cards, identification cards (ID cards), etc. Depending on a merchant's business, a merchant may limit the following privileges to one or more types of virtual cards. For example, in some systems, a merchant may select to activate the disclosed privileges only for virtual gift cards and not to virtual membership cards.

As depicted in FIG. 1, virtual card management system 10 may include a first computing device 12, a second computing device 13, a virtual card manager 14, at least one goods and services system 16, and in some systems, one or more card service providers 18. The first and second computing device may be suitable computing devices that enable a user to store and maintain one or more virtual cards. For example, the first and/or second computing device may be a smart phone, a hand-held computing device, a mobile device, a laptop computer, a portable media player, a desktop computer, etc. In some embodiments, the computing devices may run an identifiable operating system's software and provide a standardized interface and platform for applications. The computing devices may be networked to one or more networks, such as a public network (e.g. the Internet), to enable communication between the computing devices and other elements included in the virtual card management system.

The first computing device 12 may include a display 20 configured to present graphics on the device. The first computing device may also include a communication apparatus 22 facilitating wired and/or wireless communication between the computing device and external systems and devices (e.g., the virtual card manager, the goods and services system, and the card service provider) such as through a network (not shown). As depicted the first computing device may include various software applications stored on mass storage 24 (e.g., a hard drive, solid state memory, a rewritable disc, etc.,) and executable via a processor 26 using portions of memory 28. The mass storage 24 may include various programmatic elements such as a source virtual card engine 30 configured to manage one or more virtual card(s) 32. The source virtual card engine 30 may be a software application configured to implement various virtual card functions, discussed in greater detail herein.

Similar to first computing device 12, the second computing device 13 may include a display 34 configured to present graphics on the device. As mentioned above, the second computing device may also include a communication apparatus 36 facilitating wired and/or wireless communication between the second computing device and external systems and devices (e.g., the first computing device, the virtual card manager, the goods and services system, and/or the card service provider). As depicted the second computing device may include various software applications stored on mass storage 38 and executable via a processor 40 using portions of memory 42. The mass storage 38 may include various programmatic elements such as a target virtual card engine 44 configured to manage one or more virtual card(s) 46. First computing device 12 and second computing device 13 may be coupled through a network to enable electronic communication between the two devices.

The virtual cards (i.e., virtual cards 32 and virtual cards 46) may be virtual value cards, such as virtual gift cards or virtual membership cards, as described above. Each virtual card may include one or more types of card data. Example card data, includes, but is not limited to identification (ID) number, a personal identification number (PIN), a stored value, a name, a bar code, image data (e.g., picture of a card holder or other image data), data corresponding to the associated goods and services system through which the card may be used, etc.

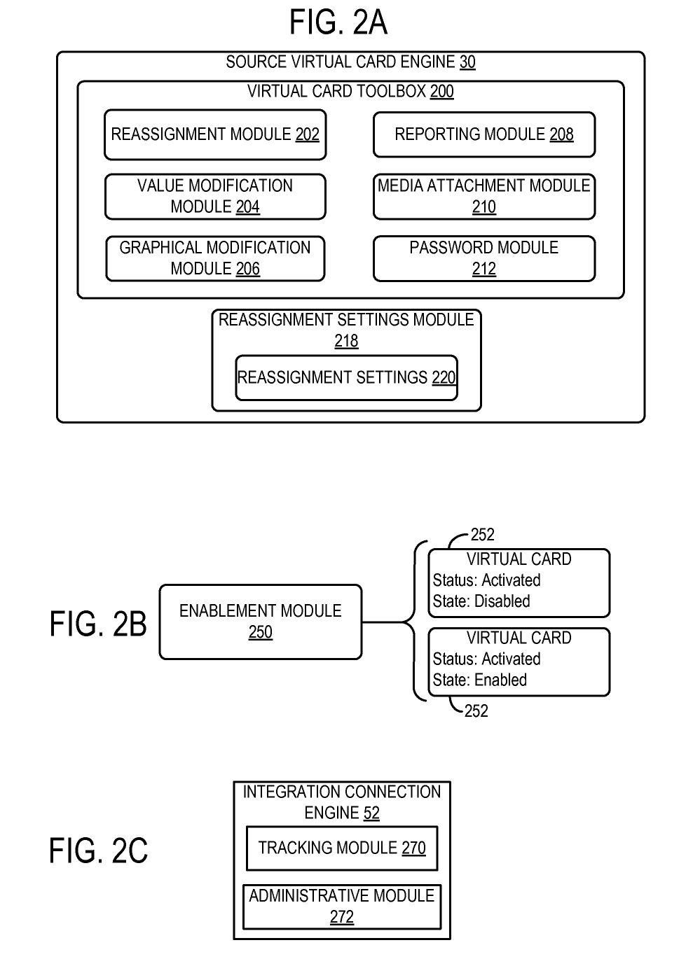

The source and target virtual card engines may be software applications configured to implement various virtual card functions to enable ease and use of virtual cards. Some of the virtual card functions may be implemented via various modules included in the virtual card engine illustrated in FIG. 2A, and described in more detail herein.

It will be appreciated that in some embodiments, a browser-based source and/or target virtual card engine may be utilized. In other words, the source and/or target virtual card engines may be executed on a remote Internet server accessible via the first and/or second computing devices. In some examples, when a browser-based virtual card engine is used, a card service provider or associated goods and services system may manage various characteristics of the virtual cards. Management of the characteristics and functions of the virtual cards may include tracking modifications to the virtual cards as made by a virtual card user. Limitations on modifications of the characteristics may be managed by the virtual card manager and such limitations may be based on selections or capabilities of the goods and services system and/or the card service provider.

Referring back to FIG. 1, the goods and services system 16 (also referred to generally as the merchant) may be a system configured to manage goods and services transactions. The merchant may be a store or other commercial establishment selling or providing goods and/or services that desires to have their card data or stored value issued electronically or virtually through a mobile or other electronic device. In some examples, the merchants may include card service providers which may be a third party service or provider that represents a gift card or other card services on behalf of a select merchant. The card service providers may be third party stored value companies, a module or software component of the merchant's existing Point of Sale (POS) software and/or provider, and/or application or software purchased, created, or used by the merchant to track the virtual card services on behalf of the merchant.

In some examples, the goods and services system 16 may be configured to virtually or electronically issue card data such as loyalty data, membership data, value data (e.g. monetary data), etc., through a computing device or other electronic device. The goods and services system may include a POS system which may include software and hardware to manage electronic transactions. It will be appreciated that the goods and services system 16 may be associated with one or more merchant outlets. Example merchant outlets may include one or more commercial establishments or businesses, including brick and mortal stores, such as coffee shops, restaurants, hotels, supermarkets, bookstores, toy stores, etc. As provided herein, the goods and services system 16 may process a virtual card transaction at a brick and mortar location, in some examples. However, in other examples, the goods and services system 16 may process a virtual card transaction over the Internet or other similar network.

One type of exemplary transaction may include an electronic transaction, such as a virtual card transaction. A virtual card transaction may include communication between two systems, devices, etc., in which value and/or privilege data is exchanged and/or manipulated. For example, a virtual card transaction may include deducting value from a virtual card in exchange for a good or service at a merchant location associated with a goods and services system. Further in other examples, a virtual card transaction may include, scanning or otherwise communicating (e.g. NFC—Near Field Communication) a virtual membership card at a merchant location associated with a goods and services system and granting access privileges to the merchant location. Further, it will be appreciated that in some examples a transaction may include implementation of security protocols.

In some embodiments, the goods and services system 16 may directly manage and control virtual card transactions. In such examples, card service provider 18 may be included in the goods and services system. However, in other examples, the goods and services system may use an external card service provider. Thus, a third party card service provider may be used in some embodiments. The card service provider may enable the goods and services system to perform virtual card transactions. As an example, the third party card service provider may be the software and hardware configured to perform virtual card transactions on behalf of a selected goods and services system. For example, the third party card service provider may include both hardware and software which, among other things, may be configured to electronically process virtual card transactions. It will be appreciated that virtual card transactions may include value transactions, such as monetary transaction in which value of a virtual card is adjusted. Additionally, the virtual card transactions may also include management of electronic privileges (e.g. card holder privileges) such as electronic access to certain types of data.

As mentioned above, card service provider 18 may be a third party stored value system or a module or software component of the goods and services system's existing POS system created or used by the goods and services system to track the virtual card services on behalf of the goods and services system. A goods and services system's POS Provider may be software, hardware, and/or other devices configured to process goods and services transactions at a location. Often times the POS may have a module or built in capability, thus making the POS System also a “Card Service Provider”.

Card service provider 18 may be configured to generate at least one provider-side associative card profile 48, each associative card profile corresponding to a virtual card. The provider-side associative card profile may be stored in a provider-side database. The provider-side associative card profile may include virtual card data such as stored value (e.g. monetary value, point value), identification (ID) data {e.g. ID number, personal identification numbers (PINs)}, a card holder's name, etc. A selected provider-side associative card profile may be accessed and adjusted during a virtual card transaction. It will be appreciated that the provider-side associative card profile may be included in the goods and services system, in some embodiments.

In some examples, virtual card manager 14 may be communicatively linked with one or more of the first computing device 12, the second computing device 13, and card service provider 18. Additionally, the virtual card manager may include at least one manager-side associative card profile 50. The manager-side associative card profile may be stored in a manager-side database. Furthermore, it will be appreciated that in some embodiments the virtual card manager may also be communicatively linked with goods and services system 16. As such, virtual card manager 14 may be configured to manage a plurality of virtual cards.

The manager-side associative card profile 50 may also include virtual card data such as stored value (e.g., monetary value, point value), identification (ID) data {e.g., ID number, personal identification numbers (PINs)}, a card holder name, etc. The provider-side associative card profile 48 and manager-side associative card profile 50 may be accessed and adjusted during a virtual card transaction.

In one example, virtual card manager 14 may be configured to manage various security features of the virtual cards such as selective enablement (e.g., access control via authentication). For example, use of a virtual card may be selectively enabled (e.g., enabled or disabled). It will be appreciated that the virtual card may have an “activated” status while the virtual card is selectively enabled. Thus, the virtual card may be “activated” but in an enabled or disabled state. Only when the card is activated and enabled is the value available for use/redemption. By using a periodic enablement system, use of the virtual card may be quickly turned “on” and “off” without deactivating the virtual card, thereby enhancing the security of the virtual card when compared to plastic gift cards which remain in an enabled state subsequent to activation. Although described in regards to a periodic enablement system, other security systems may be used to provide security to a virtual card transaction without departing from the scope of this disclosure.

To further illustrate an example security system which uses a periodic enablement system, FIG. 2B shows an exemplary use case of the enablement module according to an embodiment of the present disclosure. The enablement module 250 may be included in the virtual card manager 14. However, in other embodiments the enablement module 250 may be included in the card service provider 18. As depicted, enablement module 250 may set or enable triggering of a virtual card 252 between an enabled or disabled state. However, the virtual card may have an “activated” status. Thus, use of the virtual card may be quickly turned “on” and “off” without modifying the status of the virtual card (e.g., deactivating). The activated status of the card may indicate that the card is available for use, such that there is stored value on the card that is available for use. In some examples, where the virtual card is a virtual membership card, an activated card may be a card that is issued and the value in terms of privilege value is available. The enablement module does not affect the stored value on the card, but instead manages the usability of the card.

Again returning to FIG. 1, in some examples, the virtual card manager may include an integration connection engine 52 configured to communicatively link the virtual card manager with at least one card service provider 18 via an API or other software communication standard included in the card service provider. In this way, the virtual card manager may communicate with the card service provider. When a plurality of card service providers are communicatively linked to the virtual card manager at least a portion of the card service providers may utilize different communication protocols, communication hardware, security protocols, etc. Thus, the integration connection engine may enable the virtual card manager to interact with a number of different card service providers. In other embodiments, the card service provider may wish to use an API or other software provided by the virtual card manager to enable communication. In further examples, the card service provider may include other methods or systems for communicating with the virtual card manager. Additionally, it will be appreciated that in some systems, the integration connection engine may include one or more virtual card adapters configured to modify the data sent/or received into a common programming language, such as XML.

Virtual card manager 14 may be configured to manage various security features of the virtual cards such as selective enablement (e.g., access control via authentication). Example security features of a virtual card manager are disclosed in U.S. Non-Provisional application Ser. No. 12/554,792 filed Sep. 4, 2009 entitled SYSTEMS AND METHODS FOR AUTHENTICATION OF A VIRTUAL STORED VALUE CARD, inventor David A. Nelsen. The disclosures of which are hereby incorporated by reference for all purposes.

Thus, in some examples, a virtual card system may be set up such that a virtual card manager is capable of enabling and disabling a virtual card. A merchant may be communicatively linked to the virtual card manager. The merchant may be able to select a level of security and/or fraud protection. Depending on the security level, a rule set may be applied for virtual cards associated with the merchant. The rule set may be applied with use of virtual cards associated with the merchant.

In one example in regards to FIG. 1, a virtual card may be delivered to a user through a computing device, such as a stationary computing device or a mobile computing device. The virtual card may be delivered for use to a user's computing device (e.g. first computing device 12). Predetermined authentication rules, also referred to as security rules, may be associated with the virtual card. The authentication rules may be implemented such that the state of the virtual card (e.g. enabled state, disabled state, etc.) may be managed by the virtual card manager. In some systems, the virtual card manager may be a remote server while in other systems the virtual card manager may be on the computing device.

As an example, depending on the authentication rules, use of the virtual card may be limited to an identified computing device such that an attempt to use the virtual card from an unidentified (unassociated) computing device is blocked. When such a use is requested, the virtual card may remain in a disabled state, thereby preventing the unauthorized use of the card. Again, depending on the rule set, in some systems, a merchant may be able to over-ride the disabled state if additional identification is provided. Although the above example is described in regards to identification of a single computing device, in some examples, a user may be able to introduce additional computing devices as authorized computing devices. In such systems, the rule set may enable identification of a requesting computing device as an authorized computing device such that the state of the card is enabled.

Although only a single card service provider and computing device are depicted, it will be appreciated that virtual card manager 14 may act as a common platform for managing a large number of virtual cards corresponding to a plurality of card service providers. In some examples, two or more of the card service providers may have different characteristics. For example, two or more of the card service providers may utilize different communication protocols and may be linked to different goods and services systems and therefore provide different services. Furthermore, the card service provider may provide different types of card services. For example, one card service provider may provide membership card services while another card service provider may provide gift card services. In this way, a single virtual card management system can be used to manage a large number of virtual cards, facilitating scalability of the virtual card management system, thereby enhancing the market appeal of the virtual card management system.

Now moving to FIG. 2A, FIG. 2A illustrates a detailed schematic depiction of an example source virtual card engine 30. As previously discussed, the virtual card engine may be stored on memory executable via at least one processor. Moreover, the source virtual card engine may be executed on a computing device or a remote Internet server. In this way, a browser-based or client-based virtual card engine may be utilized.

The source virtual card engine may include a virtual card toolbox 200 having various modules that enable virtual value card management functions. The user and/or merchant may choose the module provided in the toolbox for each virtual card or virtual card type. In this way, the toolbox functionalities may be customized for one or more virtual cards or virtual card types.

Although different modules may be coupled to the virtual card toolbox, example modules include a reassignment module 202, a value modification module 204, a graphical modification module 206, a reporting module 208, a media attachment module 210, a password module 212, a reassignment setting module 218. These modules are provided as example modules and are not intended to limit the scope of the disclosure in any way.

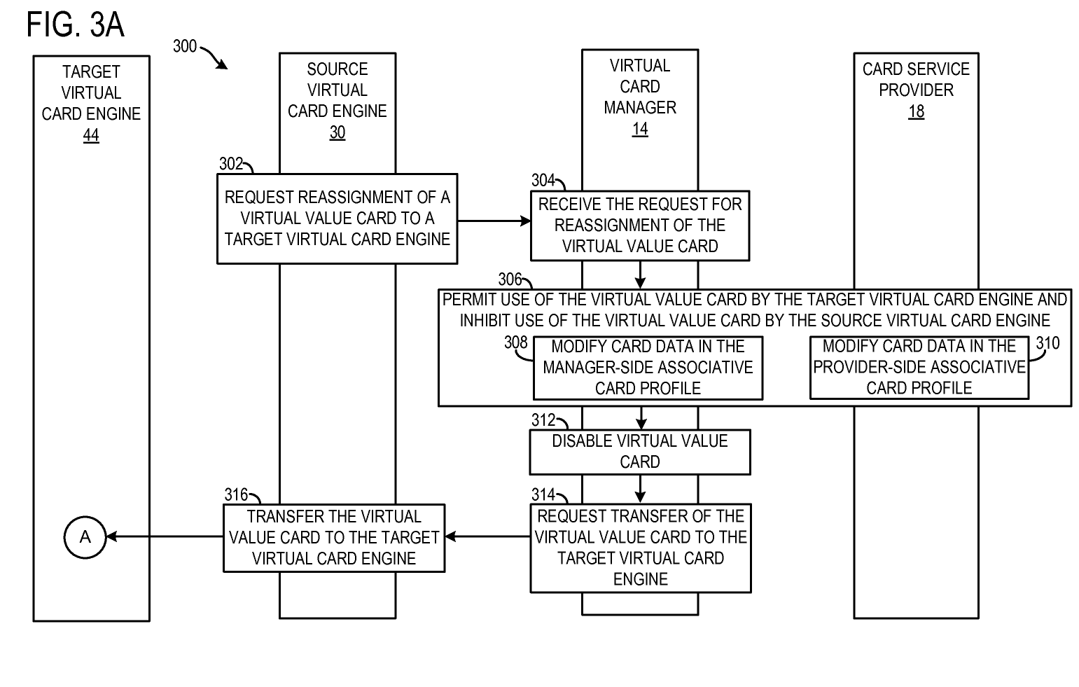

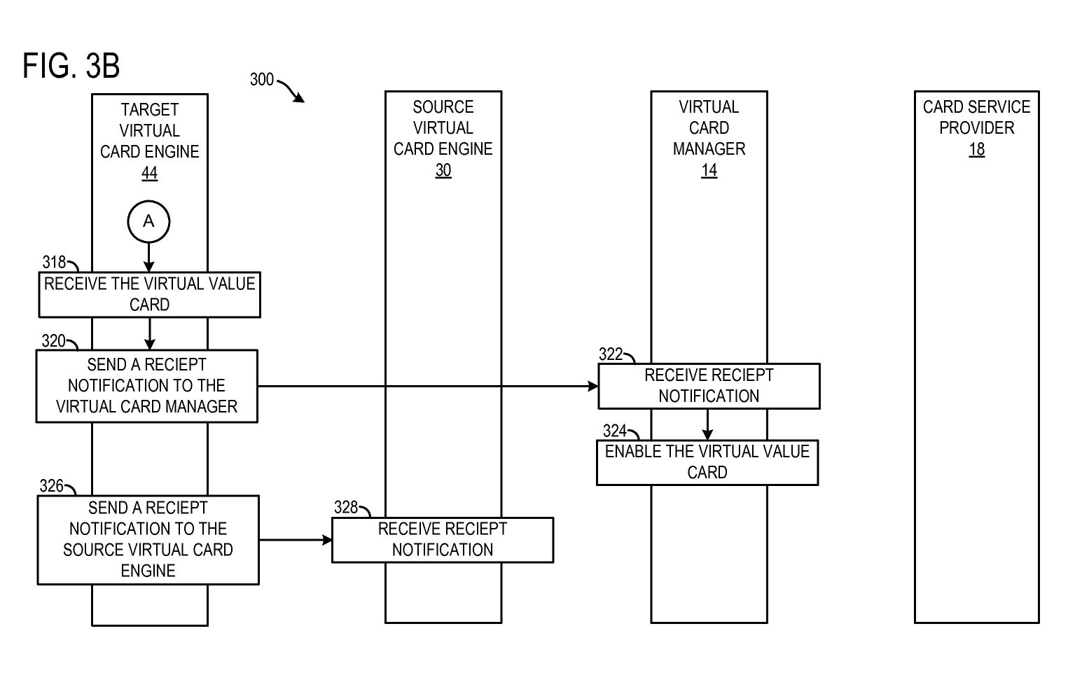

Each module may enable a user to customize and manage a virtual card received by the user. Management of the virtual card may include options to transfer or reassign the virtual card. For example, reassignment module 202 may be configured to reassign a virtual card from the source virtual card engine 30 to the target virtual card engine 44, shown in FIG. 1. In this way, a card holder may “re-gift” a virtual card to an intended recipient. Reassignment of a virtual card may include authorizing the use of the virtual card by the target virtual card engine and inhibiting the use of the virtual card by the source virtual card engine. Use of a virtual card may include implementation of a virtual card transaction (e.g., exchanging goods and services for value data stored on a virtual card). It will be appreciated that various security features may be implemented during reassignment to reduce the likelihood of fraudulent card use. The reassignment process is discussed in greater detail herein with regard to FIGS. 3A and 3B.

Continuing with FIG. 2A, the virtual card toolbox may include a value modification module 204 configured to modify value data (e.g., increase or decrease) corresponding to a virtual card based on user input. The value modification module may further be configured to send a request to an associated card service provider to modify value data in a corresponding provider-side associative card profile and/or the virtual card manager and the manager-side associative card profile. In some examples, value may be added to the virtual card from another virtual card and/or plastic card having value.

Further, in some embodiments, the value modification module may be adapted to enable minimum and maximum values that can be added to a virtual card. For example, 50 cents may be the minimum threshold value that may be added to a virtual card, due to the price of associated transaction charges. Increasing the value of a virtual card to a maximum value may be referred to as “topping off” the virtual card. Further in some embodiments, incentives may be provided by the card service provider or the merchant to increase the value of a virtual card. For example, a promotional card, virtual coupon, etc., may be offered to a user when the value of a virtual card is increased to meet or exceed a threshold value determined by the merchant or card service provider.

Further in some examples, value modification module 202 may be configured to combine value data for two or more virtual cards. In this way, a user may consolidate a number of virtual cards included in the virtual card engine. Value modification module 202 may also be configured to generate a second virtual value card and transfer a portion of the value data onto the second virtual card. In this way, a virtual card may be split. Example methods used to split the value of a virtual card and combine value cards are disclosed in U.S. Non-Provisional application Ser. No. 12/562,091 filed Sep. 17, 2009 entitled SYSTEMS AND METHODS FOR MANAGING AND USING A VIRTUAL CARD, inventor David A. Nelsen. The disclosures of which are hereby incorporated by reference for all purposes.

The virtual card toolbox may further include additional modification modules, such as example graphical modification module 206. Graphical modification module 206 may enable user customization of a virtual card. The graphical modification module 206 may be adapted to enable a user to modify the appearance of a portion or associated image of at least one virtual card presented on a display of a computing device. The appearance of the virtual card may include at least one of size, color, geometric configuration, and graphical characteristics (e.g. alpha-numeric data, images, logos, etc.). In some examples, modifying the appearance of a virtual card may include modifying an alphanumeric greeting presented directly on the virtual card or presented in a separate window when a virtual card is accessed. In this way, a user may customize and personalize the virtual card for a target recipient, thereby increasing customer satisfaction.

The virtual card toolbox may further include one or more reporting modules or status modules, such as reporting module 208. Reporting module 208 may enable a user to report a status of a virtual card, such as a “lost/stolen” status. The lost/stolen status may be a result of error in reassigning the virtual card (such as to the wrong recipient). In other examples, lost/stolen status may be a result of losing a printed virtual card or deleting the virtual card.

In some examples, a “lost/stolen” call may be sent to a virtual card manager and forwarded to a card service provider in response to user input indicating that a virtual card may be lost or stolen. However, in other examples, the lost/stolen call may be sent directly to the card service provider. In response to the “lost/stolen” call, the card service provider may reissue a new virtual card to the source virtual card engine. In some examples, re-issuing a new card may include generating a new manager-side and provider-side virtual card profile as well as generating a new virtual card and sending the new virtual card to the virtual card engine. In other examples, re-issuing a new virtual card may include redeeming the virtual card's stored value and transferring the stored value to a new provider-side associative card profile having a new identification number and/or PIN. It will be appreciated that different card service providers may have different responses to a “lost/stolen” call based on the capabilities of the card service provider. Further, in some embodiments, a report including information pertaining to the movement of monetary value in the card service provider may be sent to the merchant in response to the “lost/stolen” call. Further still, in some embodiments, the virtual card manager may disable and/or deactivate the virtual card when a “lost/stolen” call is received. In this way, a user may inhibit unauthorized use of a virtual card if they suspect that unauthorized use may occur. For example, a printed copy of a virtual card may be misplaced or possibly stolen. Therefore, a user may choose to report a virtual card “lost/stolen”. In some examples, the user may be charged for each use of the reporting module, discouraging unnecessary use. It will be appreciated that the reporting module may provide additional security against fraudulent use of a virtual card.

The virtual card toolbox may further include a media attachment module 210 configured to attach audio and/or video clips or game clips to a virtual card. In some examples, the audio or video clips may be presented directly on a displayed image of the virtual card. However in other examples, the audio and/or video clips may be presented in a separate window when a virtual card is accessed. The user may selectively attach such audio or video clips to customize the virtual card to a target recipient. In some embodiments, the target recipient may be able to replay such audio and/or video clips.

The virtual card toolbox may also include enhanced security modules, such as a password module 212. Password module may be configured to require a user to enter a password to gain access to the source virtual card engine. It will be appreciated that in some embodiments, a user may selectively activate the password module. Alternatively, the password may be determined by the user of the source virtual card engine. The password adds another level of security to prevent unauthorized use of a virtual card. The consumer controlled password may enable a user comfort that transfer or re-gifting can only occur through their initiation. In some examples, the password may be independent of a virtual card's PIN or other code. By providing this additional user password, additional security may be obtained such as in an open loop card system where the card can be used at a plurality of locations and may be more difficult to monitor.

It will be appreciated that the functionalities of the modules included in the virtual card toolbox may be implemented together in a single step. As such, various functionalities may be packaged with the reassignment process. For example, the functionalities described with regard to the value modification module, the graphical modification module, the reporting module, and the media attachment module may be carried out directly prior to or during reassignment of a virtual card to a target virtual card engine. In this way, various aspects of the virtual card may be customized by a user when a virtual card is assigned or re-gifted to an intended target recipient, enabling a user to personalize a virtual card for the intended recipient. For example, a user may increase the value of a virtual card as well as graphically modify the virtual card before a virtual card is reassigned. It will be appreciated that in some embodiments, a user may, via input, initiate reassignment of a virtual card to a target virtual card engine. After reassignment is initiated the user may be prompted by the virtual card engine to alter various aspects of the virtual card such as the card's value, the card's appearance, audio or video attached to the card, etc. However, in other embodiments, the source virtual card engine may enable a user to individually adjust various aspects of the virtual card before reassignment is initiated.

Returning again to the illustrated modules in FIG. 2A, the source virtual card engine may further include a reassignment settings module 218 including a plurality of virtual card reassignment settings 220. The reassignment settings may allow a user to selectively enable or disable the virtual card functions (e.g., toolbox functions) that may be available to a target virtual card engine to adjust various aspects of the virtual card sent from the source virtual card engine. In this way, a user may select the toolbox functions that are forwarded with the virtual card when the virtual card is reassigned. For example, a user may choose to inhibit reassignment of a virtual card after the virtual card is reassigned to a target virtual card engine. In another example, a user may choose to allow the appearance of a virtual card from being altered by the target virtual card engine. Still further, in another example, a user may choose to inhibit a message provided with a virtual card from being altered by the target virtual card engine. In some examples, the virtual card reassignment settings may be adjusted via a user interface presented on a computing device. In this way, a user may customize the reassignment process to their predilection. It will be appreciated that target virtual card engine 44 may include similar modules having similar functionality to the modules included in the source virtual card engine 30 shown in FIG. 2A. For example, target virtual card engine 44 may include at least one of a reassignment module, a value modification module, a graphical modification module, a reporting module, a media attachment module, a password module, and a reassignment settings module.

Turning now to FIG. 2C, FIG. 2C shows an example integration connection engine 52. Integration connection engine 52 may including a tracking module 270 configured to track and record information corresponding to the reassignment of one or more virtual cards. The information may include the number of virtual cards that have been reassigned, the percentage of virtual cards that have been reassigned, the frequency of reassignment, the gender of the user's who initiate reassignment, and other information regarding use of the reassignment function for a specific goods and services system. In some examples, the merchant may access a tracking report documenting the aforementioned information via a computing device. In this way, a merchant may access statistical information about the virtual cards and use of the virtual cards. In addition, the tracking module may allow a merchant to be in compliance with escheatment laws which may require unclaimed property to be returned to government bodies if the property is not claimed over an extended period of time.

The integration connection engine may further include an administrative module 272 configured to manage the toolbox functionalities assigned to each virtual card administered by the virtual card manager. For example, the administrative module may enable a first set of virtual cards to be reassigned and inhibit a second set of virtual cards from being reassigned. Additionally, the administration module may be configured to manager various fraud and security elements for each card administered by the virtual card manager.

Turning now to FIGS. 3A and 3B, an example reassignment method 300 is illustrated providing for reassignment of a virtual card from a source virtual card engine to a target virtual card engine. As shown, the method may be implemented via source virtual card engine 30, target virtual card engine 44, virtual card manager 14, and card service provider 18. However, in other embodiments method 300 may be implemented by other suitable systems, modules, components, etc.

At 302, the method includes requesting reassignment of a virtual value card from the source virtual card engine to a target virtual card engine. It will be appreciated that user input may trigger the reassignment request. In some examples, various aspects of the virtual value card may be altered before or during a reassignment request, such as altering the appearance of the virtual value card, adjusting the value of the virtual value card, attaching media (e.g., audio and/or video files), and/or altering the greeting provided with the virtual value card. In this way, a user may customize the virtual card before it is reassigned.

Next at 304 the method includes receiving the request for reassignment of the virtual value card via the virtual card manager. In some examples, the virtual card manager may selectively authorize the reassignment of the virtual value card depending on the authorization or capabilities of the goods and services system and/or the card service provider. In this way, reassignment of certain virtual cards may be permitted while reassignment of other virtual cards may be inhibited. As previously discussed the card service provider and/or the merchant may determine which virtual cards may be authorized for reassignment.

Next, at 306, the method includes permitting use of the virtual value card by the target virtual card engine and inhibiting use of the virtual value card by the source virtual card engine. Use of a virtual value card may include implementation of a virtual card transaction (e.g., an exchange of goods and services for value data stored on the virtual card). As depicted the virtual card manager and card service provider may both implement step 306. However, it will be appreciated that alternate or additional system elements, such as the goods and services system, may be used to implement step 306. Further, in some systems, the implementation may be completed by only one of the virtual card manager, the card service provider or the goods and services system. The implementation may be communicated to the linked system elements.

In some examples, permitting use of the virtual value card by the target virtual card engine and inhibiting use of the virtual value card by the source virtual card engine may include modifying card data in the manager-side associative card profile at 308 and modifying corresponding card data in the provider-side associative card profile at 310. It will be appreciated that virtual card data may include the virtual card's identification number and/or the virtual card's PIN. However, in other examples, alternate methods may be used to permit use of the virtual value card by the target virtual card engine and inhibit use of the virtual value card by the source virtual card engine. In one example method, a new manager-side and provider side associative card profile may be generated. Value data from the old associative card profiles may be transferred to the new profiles and the old profiles may be subsequently deleted or reclassified. Further, in some embodiments, the computing device executing the target virtual card engine may be authenticated for use of the virtual value card while the computing device executing the source virtual card engine inhibited from use of the virtual value card. In other words, the computing device executing the target virtual card engine may be authorized to selectively enable the virtual value card while the computing device executing the source virtual card engine may be inhibited from selectively enabling the virtual value card. In such a case, any party privy to the card information (e.g., card identification number, PIN, etc.) would not have the ability to use the virtual value card to perform a transaction unless the virtual value card is presented with the target computing device. Such a system may further enhance the card's security. It will be appreciated that in systems which incorporate periodic authentication, authentication of the virtual card may be verified several times during the reassignment process.

The reassignment of the virtual card introduces security issues which are addressed through an enabling/disabling authentication system described herein. Where security has not been fully implemented, transfer of a virtual value card could compromise the card and the value of the card. For example, duplicative versions of the virtual value card may be reproduced or used after the virtual value card is reassigned. Further, attempts to “resell” a virtual value card a second time, while retaining the card number and enable use of the card prior to giving the reassigned user an opportunity to use the card are risks without fully-implemented security. The disclosed enabling/disabling authentication system limits these security risks, however other systems may also be used to limit the risks and are within the scope of this disclosure.

Next, at 312, the method includes disabling the virtual value card. In this way, use of the virtual card during the reassignment process may be inhibited. Value has transferred with reassignment of the virtual value card. In some examples, step 312 may be excluded from method 300 or may occur after reassignment of the virtual value card has been completed.

Next, at 314, the example method includes requesting transfer of the virtual value card from the virtual card manager to the target virtual card engine from the source virtual card engine. In some examples, the transfer request may include modified card data, such as the virtual value card's new identification number and/or PIN. The transfer request may be automatically managed by the virtual card manager once authentication of the virtual value card has been completed.

At 316, the method includes transferring the virtual value card from the source virtual card engine to the target virtual card engine. Transferring the virtual card may include transferring value from the source virtual card engine to the target virtual card engine. The transfer may be managed by the virtual card manager through the source virtual card engine or through a reassignment process where a new virtual value card is issued to the target virtual card engine. In some embodiments, various virtual card data (e.g., identification number, PIN) may be modified when the virtual card is transferred. However in other embodiments the virtual value card may be sent to the virtual card manager where the virtual card data is modified and then sent to the target virtual card engine.

Next, at 318, the method includes receiving the reassigned virtual value card via the target virtual card engine. In some examples receiving the reassigned virtual value card may include receiving a notification, such as an email or other message, of receipt of a virtual value card. For example, the notification may enable access to a link or may open a link included in the notification directing the user to a remotely executed target virtual card engine configured to manage the virtual card.

At 320, the method includes sending a receipt notification to the virtual card manager from the target virtual card engine. At 322 the method includes receiving the receipt notification and at 324 enabling the virtual value card. In this way, use of the virtual value card may be disabled until the virtual value card is transferred to the target virtual card engine. In some examples, the virtual value card may be enabled in response to authentication of the target virtual card engine. Authentication of the target virtual card engine may include opening a link provided with the virtual card and personally identifying themselves with requested information determined by the source virtual card engine.

The method may further include at 326 sending a receipt notification to the source virtual card engine from the target virtual card engine and at 328 receiving the receipt notification. As such, a user may be informed when the target virtual card engine has received the virtual value card. In some embodiments, the receipt notification may be sent after the virtual value card has been accessed via the target virtual card engine. Further, in some embodiments, the receipt notification may be sent via email or other messaging system. Still further in some embodiments one or more social networking sites, such as Facebook® and Twitter®, may be use to track and update the re-gift process. For example, one or more social networking sites may be notified when the virtual value card is received by the target virtual card engine. In response to notification, various actions such as posting information, sending messages, etc. may be provided through the social networking sites.

Further still, in some examples, the merchant may be updated during the reassignment process. For example, the merchant may receive updated virtual card data, such as the name of the intended recipient of the virtual value card. The merchant may then require the recipient of the card to provide identification during a virtual card transaction to verify that they are in fact authorized to use the virtual value card, further enhancing the security of the virtual value card during the reassignment process.

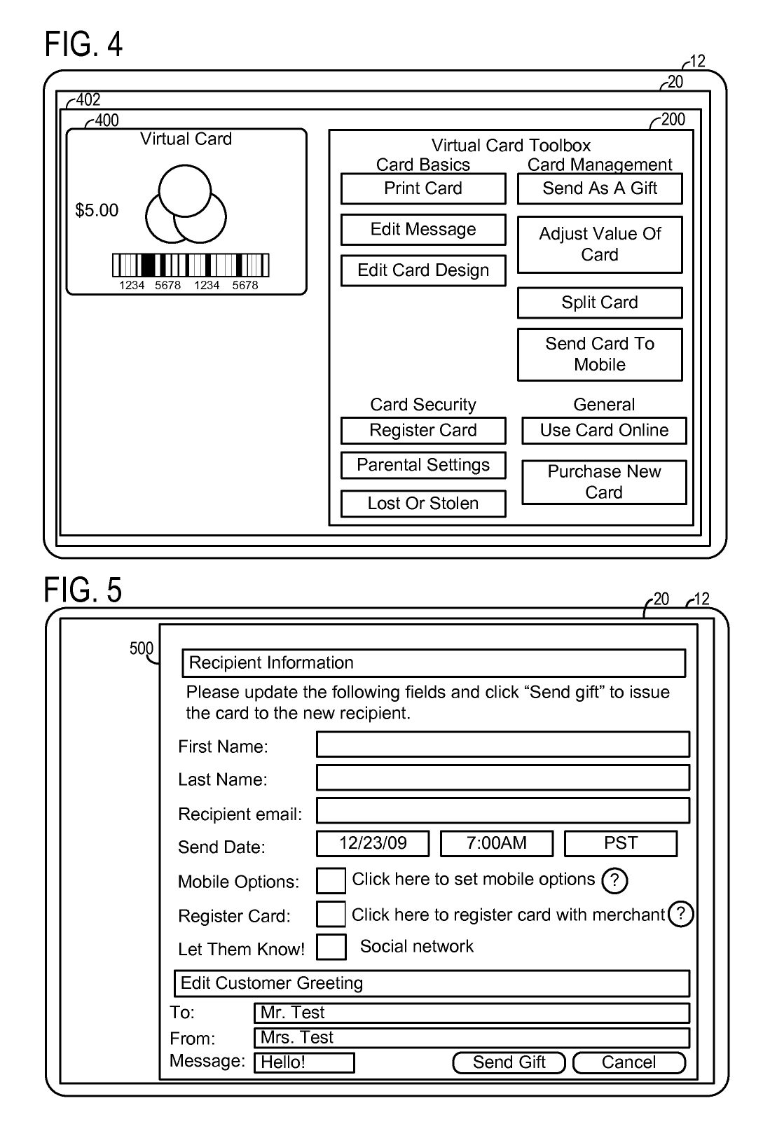

FIGS. 4-9 show various examples of the first computing device 12 which may present various content windows on display 20 to enable the functionality of the source virtual card engine shown in FIG. 2, according to various embodiments of the present disclosure. As previously discussed the virtual card engine may be executed on a computing device or executed via a remote Internet server. It will be appreciated that the content windows are exemplary in nature and alternate content window may be provided to enable the functionality of the source virtual card engine in other embodiments.

As an example, FIG. 4 shows first computing device 12 including display 20 on which an exemplary virtual value card 400 and virtual card toolbox 200, such as the illustrated toolbox utility panel, are presented in a content window 402. The user of first computing device 12 has virtual value card of $5.00 retained in their source virtual card engine 30. The virtual card toolbox display provides user selection inputs to enable user-management, user-customization and reassignment. As shown, the virtual card toolbox includes various buttons or other suitable graphical elements that enable implementation of toolbox functions. It will be appreciated that some toolbox buttons may directly trigger a toolbox function while other buttons may trigger the presentation of a content window configured to enable a user to implement a toolbox function. Further, it is noted that certain types of cards may or may not use the toolbox. For example, a promotional virtual stored value card may limit toolbox functions, such that the user may not be able to change card design or re-gift.

The button labeled “Print Card” may be configured to print an image of the virtual value card in response to user selection. A user may select to print the virtual value card for redemption. Selection of the buttons labeled “Edit Message” and “Edit Card Design” may trigger presentation of at least one appearance adjustment window on the computing device. The user may edit the message and/or card design from the received gift card which may have been previously stylized by the merchant or selected by the original provider of the card. As such, the appearance adjustment window may be configured to enable adjustment and customization of the appearance of the virtual value card. For example, a user may have received a virtual value card during Christmas and the virtual card has related Christmas presentation effects and messages. The user may edit the virtual card to match a new theme—such as Father's Day or the Fourth of July—changing the message and theme for presentation and viewing of the virtual card. The graphical modification module 206 shown in FIG. 2A may provide the programmatic functionality to the appearance adjustment window.

Selection of the button labeled “Send As Gift” may trigger the presentation of a reassignment window. The reassignment window may be configured to enable implementation of reassignment of a virtual value card from a source virtual card engine to a target virtual card engine. Reassignment module 202, shown in FIG. 2A, may provide the programmatic functionality to the reassignment window. In this way, a user may choose to reassign a virtual value card to a target virtual card engine.

Selection of the button labeled “Adjust Value Of Card” may trigger the presentation of a value adjustment window on the computing device. The value adjustment window may enable a user to adjust or add value to the virtual value card. Value modification module 202, shown in FIG. 2A, may provide the programmatic functionality to the value adjustment window. Further in some examples, the stored value of the virtual value card may be adjusted during reassignment.

Selection of the button labeled “Split Card” may trigger the presentation of a card splitting window. The card splitting window may enable a user to divide the value of the virtual value card between multiple virtual value cards. Value modification module 204, shown in FIG. 2A, may provide the programmatic functionality to the card splitting window.

Selection of the button labeled “Send Card To Mobile” may send the virtual value card to a user selected mobile computing device. Selection of the button labeled “Register Card” may register an intended recipient of the virtual value card with the merchant before reassignment is initiated, in case the virtual value card is lost during reassignment. The button labeled “lost or stolen” may enable a user to report the virtual value card lost or stolen to the virtual card manager.

The button labeled “parental setting” may enable a user to set various parental controls for the virtual value card. For example, in some systems, a gifting party may permit use at only a select merchant location, limit reassignment, or the gifting party may otherwise restrict or control use of the value card by the receiving party. Further, in some systems, a settings button may be set by the gifting party. Exemplary settings that may be included on the virtual card include: a selection to allow the card to be re-gifted or reassigned; a selection to allow a user to turn off the ability to allow the recipient to edit the message; a selection to allow a user to turn off the ability to edit the card design; a selection to turn on or off other customization functionality.

The button labeled “use card online” may enable a user to make purchases with the virtual card online. In some examples, an online merchant outlet may be configured to provide one click purchasing when the virtual value card is used as a form of payment online. The button labeled “Purchase New Card” may enable a user to purchase a new card.

As previously discussed the merchant may select the toolbox functionalities available for each virtual card. Therefore it will be appreciated that in other embodiments the set of functions provided in the virtual card toolbox may be altered.

FIG. 5 shows an example reassignment window 500 that may be presented on the display 20 of the first computing device 12 in response to selection of the button labeled “Send As Gift”. Various inputs fields are show which may allow a user to provide the intended recipients name, email address, as well as the date and time they wish to reassign the virtual card. In the depicted example, additional enhancement features are also be bundled into the reassignment window. The illustrated enhancement features include greeting input fields enabling a user to customize the greeting provided with the virtual card. The user may edit a prior greeting, personalizing the greeting and customizing the virtual card to the target recipient. Such customization enables the virtual value card to have dynamic presentation capabilities from the virtual card real-time as opposed to only allowing the original gifting party such customization capabilities. Additional enhancement features may be provided with various check boxes or other suitable type of buttons. For example, the checkboxes may allow a user to register the virtual value card with a merchant during reassignment of the virtual value card, enable selected mobile devices to access the virtual value card, or trigger generation of social networking posts when the virtual value card is reassigned. Other enhancement features may be provided and the disclosure is not intended to be limiting in scope.

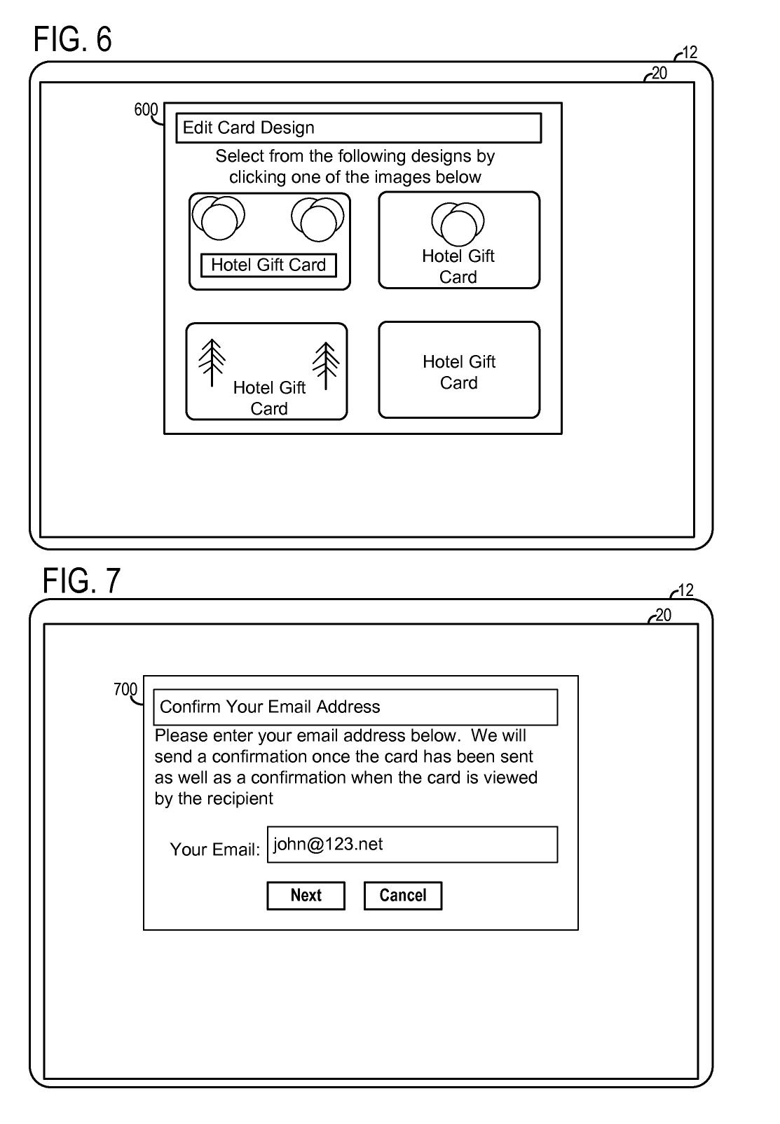

FIG. 6 shows an appearance adjustment window 600 that may be presented on display 20 of the first computing device 12 in response to selection of the button labeled “Edit Card Design” shown in FIG. 4. The appearance adjustment window may enable a user to alter the appearance of a virtual value card. As shown a user may select a virtual card design from a number of predetermined designs or themes. However, in other embodiments the user may alter individual aspects of the appearance such as the color of the card, the layout of the graphics presented on the card, the type of graphics presented on the card, the font of the text presented on the card, etc. For example, a user may be able to send a personal photograph or other image as the virtual value card graphics. Further, a user may be able to select a series of images to be displayed in a select pattern with receipt of the virtual value card. Further, users may add or attach accessories with the virtual value card, including electronic greeting cards or other electronic packaging. Other customization of the appearance and presentation of the virtual value card may be provided and are within the scope of the disclosure.

FIG. 7 shows a notification window 700 that may be presented on display 20 of the first computing device 12 in response to selection of the button labeled “Send As Gift”, shown in FIG. 4. It will be appreciated that the notification window may be displayed in addition to the reassignment window 500, shown in FIG. 5, in some embodiments. The notification window may be configured to enable the source virtual card engine to receive a notification via email or other suitable messaging service when the target virtual card engine has receive a virtual value card during a reassignment process.

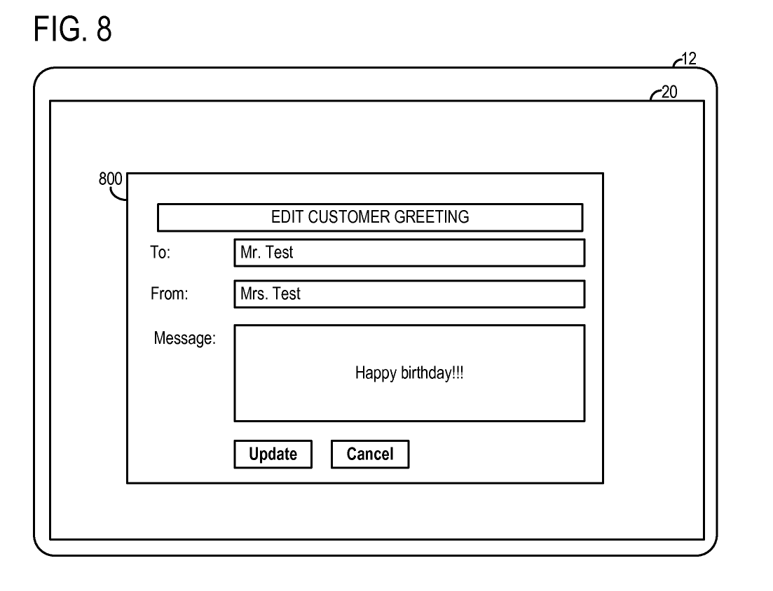

FIG. 8 shows a greeting adjustment window 800 that may be presented on display 20 of the first computing device 12 in response to selection of the button labeled “Edit Message”. In this way, a user may customize a greeting provided with a virtual card. The user may further select different features, such as color, font type, font size, font position, etc. to further enhance the virtual value card. Further customization, including audio, voice, video or game attachments may be provided to enhance user experience with the virtual value card.

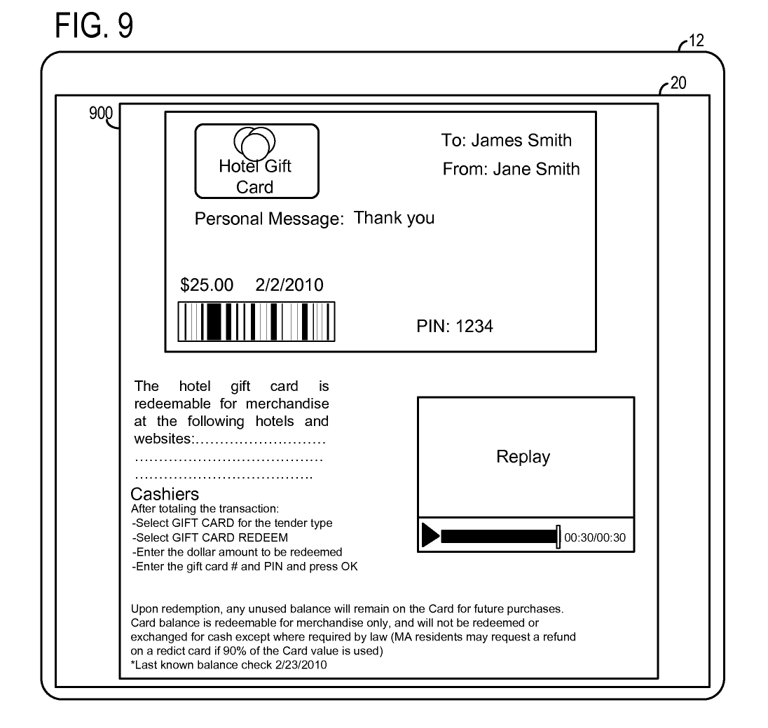

As an example, FIG. 9 shows a virtual value card presented with a video attachment in a content window presented as a gift. The virtual value card may be reassigned with the customized features such as the video clip and personal message. The target recipient can replay the video and use the virtual card value for redemption at the corresponding merchant (and/or reassign the virtual card depending on permissions). A recipient may be able to use the virtual value card through the corresponding merchant by presenting the virtual value card to the merchant at a brick and mortar location, or in some systems, through an online merchant location. With the online purchases, a recipient may be able to link directly to the online merchant location through the virtual value card and purchase goods or services through use of the virtual value card. In some systems, the use of the target computing device for presenting the virtual value card may enable authorization of use of the virtual value card such that no additional codes or numbers need to be inputted to enable purchase.

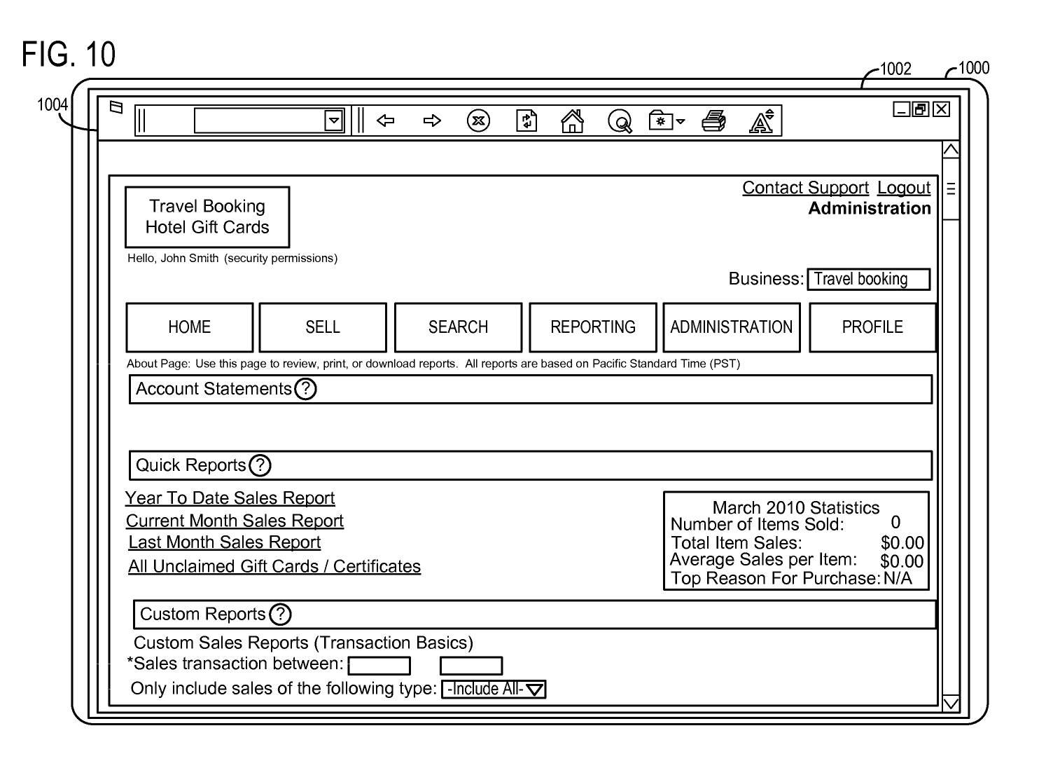

FIG. 10 shows an exemplary content window 1004 presented on display 1002 of computing device 1000. Content window 1004 may be used by the merchant to access the reporting module to provide various statistical data corresponding to the virtual value cards. The statistical data may include various virtual card sales reports, virtual card invoices, and itemized statements. In this way a merchant may view relevant statistical data pertaining to the use of the virtual value cards.

The systems and methods described herein allow a user to easily and securely reassign a virtual value card from a source virtual card engine to a target virtual card engine. In this way, a user may transfer ownership (e.g., “re-gift”) of a virtual value card to a desired recipient, such as a friend, family member, etc. The reassignment process may include various security features, such as disabling the virtual card, which may decrease the likelihood of unauthorized use of the virtual value card. The systems and methods further enable a user to customize various aspects of the virtual value card, such as the virtual card's value and appearance, in conjunction with reassignment, enabling the virtual card to be dynamically changed throughout the card's lifetime.

It should be appreciated that the example of reassignment is directed to reassignment of a virtual gift card. However, as described above, the system and method may also be used with other types of virtual value cards, including a virtual membership card. For example, in some systems a merchant may enable users holding virtual membership cards to selectively transfer a portion of the privileges tied to the virtual membership cards. For example, a merchant may own and operate gyms or other work-out facilities. Members may retain virtual membership cards where the member may selectively reassign some or all of the membership privileges to a target recipient depending on the merchant's rules. As an example, a merchant owning or operating a work-out facility may enable members to reassign to a target recipient a three-day trial membership to the work-out facility. As such, the reassignment methods and systems described above may be used to manage the reassignment of the virtual membership offer. Likewise, the reassignment may be used with virtual promotional cards, virtual rewards cards, etc.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A method for reassigning a virtual value card in a virtual card management system comprising at a virtual card manager:
receiving a request for reassignment of the virtual value card from a source virtual card engine to a target virtual card engine; and
modifying card data in a manager-side associative card profile included in the virtual card manager and requesting modification of card data in a provider-side associative card profile to permit use of the virtual value card by the target virtual card engine and inhibit use of the virtual value card by the source virtual card engine in response to reception of the request for reassignment.

2. The method of claim 1, wherein modifying card data in a manager-side associative card profile includes authorizing the target virtual card engine for selective enablement of the virtual value card and inhibiting the source virtual card engine from selective enablement of the virtual value card, selective enablement includes setting the virtual value card in an enabled and disabled state.

3. The method of claim 1, further comprising at the virtual card manager, requesting transfer of the virtual value card to the source virtual card engine from the target virtual card engine, subsequent to modifying card data.

4. The method of claim 3, wherein requesting transfer includes requesting modification of card data in the virtual value card to match card data included in the manager-side and provider-side associative card profiles.

5. The method of claim 3, wherein requesting transfer includes requesting modification of value data in the virtual value card transfer to the target virtual card engine.

6. The method of claim 3, further comprising at the virtual card manager, subsequent to requesting transfer of the virtual value card, receiving a verification of virtual value card reception from the source virtual card engine that the virtual value card has been received, and in response to the reception of the verification setting the virtual value card in an enabled state while retaining the virtual value card in an active status.

7. The method of claim 1, wherein modifying card data include modifying at least one of the virtual value card's identification number and the virtual value card's personal identification number (PIN).

8. The method of claim 1, further comprising at the virtual card manager, subsequent to the step of modifying, setting the virtual value card in a disabled state while retaining the virtual value card in an active status.

9. The method of claim 1, wherein the virtual value card is one of a virtual gift card, a virtual loyalty card, a virtual rewards card, a prepaid card, and a virtual membership card.

10. The method of claim 1, wherein the virtual value card retains stored value configured to be exchanged for at least one of a good and a service provided by a goods and services system in electronic communication with the target virtual card engine.

11. A virtual card management system for reassigning a virtual value card comprising:
a virtual card manager including code stored in memory executable by a processor to:
receive a request for reassignment of a virtual value card from a source virtual card engine to a target virtual card engine;
modify card data to permit use of the virtual value card by the target virtual card engine and inhibit use of the virtual value card by the source virtual card engine in response to reception of the request for reassignment; and
send a request to the source virtual card engine to transfer the virtual value card from the source virtual card engine to the target virtual card engine.

12. The virtual card management system of claim 11, wherein the virtual card manager further comprises code stored in memory executable by the processor to receive verification from the source virtual card engine or reception of the virtual value card, and in response to the reception of the verification enable the virtual value card.

13. The virtual card management system of claim 11, wherein the virtual value card includes value data configured to be exchanged for at least one of a good and service in a goods and services system in electronic communication with the target and source virtual card engines.

14. The virtual card management system of claim 11, wherein the virtual card manager further comprises code stored in memory executable by the processor to disable the virtual value card subsequent to modification of the card data.

15. The virtual card management system of claim 14, wherein disabling the virtual value card includes setting the virtual card in a disable state while retaining the virtual value card in an active status.

16. The virtual card management system of claim 11, wherein modifying card data include modifying at least one of the virtual value card's identification number and the virtual value card's personal identification number (PIN).

17. A method for reassigning a virtual value card in a virtual card management system, the method comprising, at a virtual card manager:
receiving a request for reassignment of the virtual value card from a source virtual card engine to a target virtual card engine;
modifying card data in a manager-side associative card profile included in the virtual card manager and requesting modification of card data in a provider-side associative card profile to permit use of the virtual value card by the target virtual card engine and inhibit use of the virtual value card by the source virtual card engine in response to reception of the request; and
requesting transfer of the virtual value card to the source virtual card engine from the target virtual card engine.

18. The method of claim 17, wherein modifying card data in a manager-side associative card profile includes authorizing the target virtual card engine for selective enablement of the virtual card and inhibiting the source virtual card engine from selective enablement of the virtual value card, selective enablement includes setting the virtual value card in an enabled and disabled state.

19. The method of claim 17, further comprising at the virtual card manager, subsequent to the step of modifying, setting the virtual value card in a disabled state while retaining the virtual value card in an active status.

20. The method of claim 17, wherein modifying card data include modifying at least one of the virtual value card's identification number and the virtual value card's personal identification number (PIN).
